(19) United States
(12) Patent Application Publication
(10) Pub. No.: US 2012/0066252 A1
(43) Pub. Date: Mar. 15, 2012

(54) MEDIUM AND METHOD FOR COLLECTION OF INFORMATION, AND INFORMATION COLLECTION SUPPORT SYSTEM

(75) Inventors: Naoki HAYASHI, Kanagawa (JP); Masamichi TAKAHASHI, Kanagawa (JP)

(73) Assignee: FUJI XEROX CO., LTD., Tokyo (JP)

(21) Appl. No.: 13/030,735

(22) Filed: Feb. 18, 2011

(30) Foreign Application Priority Data
Sep. 13, 2010 (JP) 2010-204785

(51) Int. Cl. G06F 17/30

(52) U.S. Cl. 707/769; 707/E17.014

(57) ABSTRACT

A computer readable medium storing a program causing a computer to execute a process for collection of information, includes receiving a division condition of a value range of an attribute from a user; dividing the value range of the attribute into a plurality of ranges under the received division condition; selecting writers who have an attribute value corresponding to the respective divided ranges of the attribute by referencing a writer information storage unit that stores values of the attribute of the writers; collecting information that is posted by the selected writers from a posted information storage device that stores information posted by the writers; and providing the collected information to the user.

### CROSS-REFERENCE TO RELATED APPLICATIONS

This application is based on and claims priority under 35 USC 119 from Japanese Patent Application No. 2010-204785 filed Sep. 13, 2010.

### BACKGROUND

(i) Technical Field

The present invention relates to a program and a method for collection of information, and an information collection support system.

(ii) Related Art

On information communication networks such as the Internet and a corporate intranet, information is newly created everyday and distributed without limitation or within a predetermined range by using various systems and services, such as a document management system, various databases like a research paper database, an electronic bulletin board, a blog (Web log), and an image- or movie-sharing service.

A typical approach is to selectively provide information to a user if the information meets the liking and interest of the user from an enormous amount of information on the network. A tool or a system that automatically collects information relating to the user and provides the information to the user has been suggested.

### SUMMARY

A computer readable medium storing a program causing a computer to execute a process for collection of information according to an exemplary embodiment of the invention, includes receiving a division condition of a value range of an attribute from a user; dividing the value range of the attribute into a plurality of ranges under the received division condition; selecting writers who have an attribute value corresponding to the respective divided ranges of the attribute by referencing a writer information storage unit that stores values of the attribute of the writers; collecting information that is posted by the selected writers from a posted information storage device that stores information posted by the writers; and providing the collected information to the user.

### BRIEF DESCRIPTION OF THE DRAWINGS

Exemplary embodiment(s) of the present invention will be described in detail based on the following figures, wherein:

FIG. 1 illustrates an example of a system configuration according to an exemplary embodiment;

FIG. 2 illustrates an example of data contents stored in a work style information storage unit;

FIG. 3 illustrates an example of a collection condition setting window;

FIG. 4 illustrates an example of a flow of collection condition setting processing;

FIG. 5 illustrates an example of writer selection conditions from among collection conditions stored in a condition storage unit;

FIG. 6 illustrates an example of a flow of processing that provides information to a user;

FIG. 7 illustrates an example of a list display window for provided information; and

FIG. 8 illustrates an example of a window that displays the detail of a piece of information selected from the list display window.

### DETAILED DESCRIPTION

An approach that is collecting information that meets the interest of a user is a natural and necessary way. However, if collection of information in this way is repeated, information collected may become limited to a certain aspect, and the view of the user may be forced to be narrow. Accordingly, this exemplary embodiment suggests a system that intentionally collects multifaceted information and provides the information to a user.

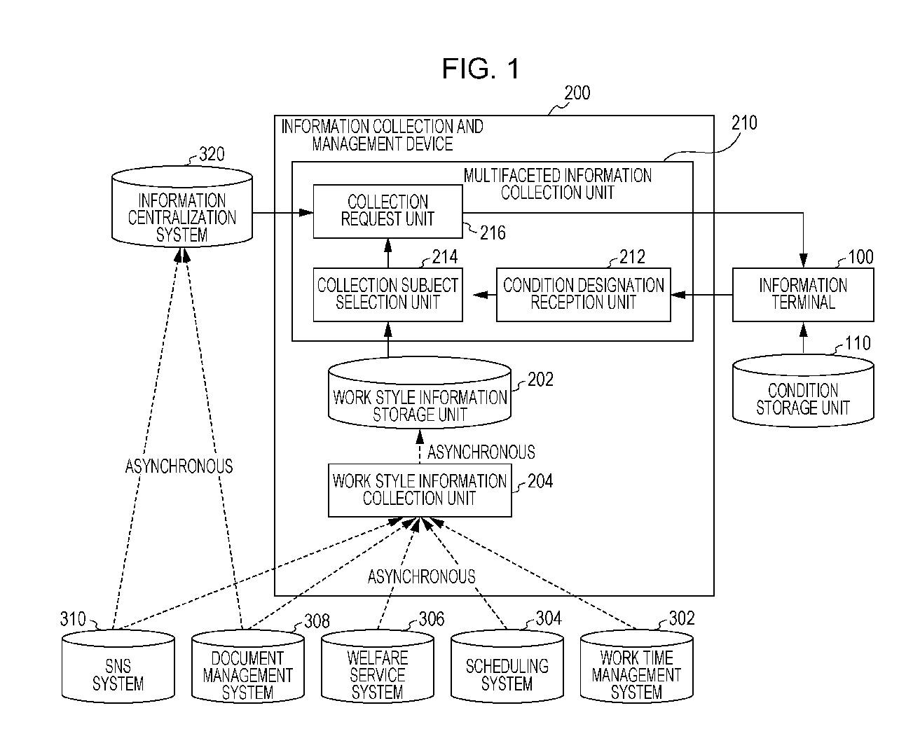

Referring to FIG. 1, an example of a system configuration according to the exemplary embodiment is described. Described in this exemplary embodiment is, for example, a system that collects information that is posted by an employee in a corporation, i.e., information that is created and distributed (or distributed limitedly) by the employee in the corporation, and provides the information to other employees in the corporation through a corporate network.

In FIG. 1, an information terminal 100 is a terminal apparatus mounted on a computer that is operated by a user. For example, the information terminal 100 may be a personal computer or a workstation of desktop type, notebook type, or tablet type, a personal digital assistant (PDA), a smartphone, or other cellular phone. A condition storage unit 110 is a device that stores “information collection conditions” set by the user of the information terminal 100. The condition storage unit 110 may be a storage device included in the information terminal 100, or a storage device capable of making communication with the information terminal 100 through a network or the like. In the latter case, the condition storage unit 110 assigns user identification information (ID) to users of plural information terminals 100, and stores the information collection conditions set by the user. If the condition storage unit 110 is included in the information terminal 100 and the information terminal 100 could be used by plural users, the condition storage unit 110 may store the information collection conditions on a user basis. Specific examples of the information collection conditions will be described later.

An information collection and management device 200 is a computer which is capable of making communication with the information terminal 100 through an information communication network, such as the Internet or a corporate intranetwork (for example, local area network). The information collection and management device 200 manages information collecting activities for the information terminal 100 (user). The information collection and management device 200 includes functional modules including a work style information storage unit 202, a work style information collection unit 204, and a multifaceted information collection unit 210.

The work style information storage unit 202 is a functional module that stores work style information of users who are registered in the system according to this exemplary embodiment. In this exemplary embodiment, users (users who post information) as supply sources of information that are posted to the information terminal 100 are selected based on attributes corresponding to work styles (ways of working) of the respective user.

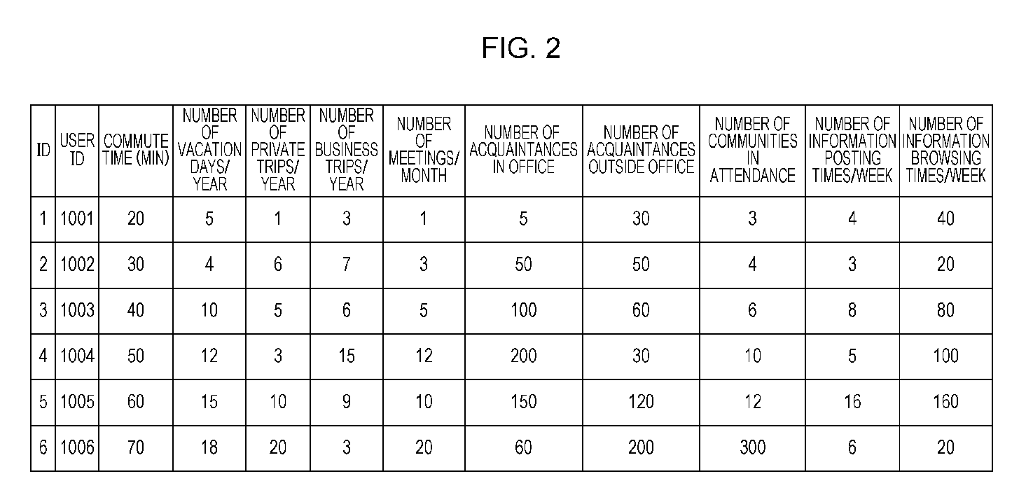

FIG. 2 illustrates an example of work style information that is stored in the work style information storage unit 202. A single row in a table shown in FIG. 2 represents a record for one user. The record includes values of respective attribute items including an ID (identification information) of the record itself, an ID of a user of a record subject. In addition in association with these IDs, the attribute items include user's personal attributes such as a commute time, the number of vacation days per year, the number of private trips per year, the number of business trips per month, the number of meetings per month, the number of acquaintances in an office, the number of acquaintances outside the office, the number of communities in attendance, the number of information posting times per week, and the number of information browsing times per week. An example of a community in attendance may be a community that is registered in an SNS system 310.

Among the attribute items of the exemplary work style information illustrated in FIG. 2, the commute time, the number of vacation days, the number of private trips, the number of business trips, and the number of meetings may be attributes that represent aspects of the way of working of the user. For example, the commute time and the number of vacation days may represent the lifestyle of the user, and the number of private trips and the number of business trips may represent the store of knowledge of the user. Also, the number of acquaintances in and outside the office and the number of communities in attendance may represent aspects of personal connections of the user. Further, the number of information posting times and the number of information browsing times may represent the way of commitment to information of the user. Hence, if the users are divided into groups in the aspects of these attribute items (based on ranges of attribute values), and if writers are respectively selected from the groups, various writers in such viewpoints may be selected. If the user collects information distributed/posted by the various writers and browses the information, the user may obtain multifaceted information easier.

In this example, the user is an employee of a corporation that uses the system. The user ID may be, for example, an employee ID that is used in the corporation. The user logs in various information systems (e.g., a document management system 308 and the SNS system 310, which will be described later) on the corporate network by using the employee ID of the user. Not all information processing systems on the network have to use the employee IDs as the user IDs. However, it is assumed that the user IDs in each information processing system may be converted into the employee IDs by a directory server (not shown) or the like. Each employee logs in each system, such as the document management system 308 or the SNS system 310 provided on the network, browses and posts a document or other information. Each system stores the document posted by the log-in user in association with the user ID; and records an action performed by the user, such as browsing or posting, in the system and an object of the action (information such as a document or the like) as log information. It is to be noted that since the employee of the corporation is a user of the system according to this exemplary embodiment, hereinafter, the employee is merely called user unless the employee has to be particularly distinguished from a mere user. When the user represents a person who posts information, the user may be occasionally called a writer.

The information that is stored in the work style information storage unit 202 is collected by the work style information collection unit 204 from various information sources provided on the network. For example, the information sources include a work time management system 302, a scheduling system 304, a welfare service system 306, the document management system 308, and the social networking service (SNS) system 310.

The work time management system 302 manages information of an attendance state of each user (for example, information of used vacation days, start and end times of work, and a commute time). The scheduling system 304 manages information of a work schedule of each user (for example, information of a schedule of business trips and meetings). The welfare service system 306 manages a use status of welfare services of each user (for example, information of attending private trips). The document management system 308 saves an electronic document (for example, a document file created with a word processor) posted by each user (in this case, the user is a writer because the user creates a document and posts it as information), and distributes the saved document to each user in accordance with access control information if it is set. The SNS system 310 provides a social networking service. For example, the functions of the SNS system 310 include a profile publishing function, a user searching function, a blog posting function, a community creating function, and an information sharing function in the community. The document management system 308 and the SNS system 310 are examples of systems that serve as fields where users share the information. In addition to the aforementioned systems, a system for distribution of information, such as an electronic bulletin board system, may be provided. The document management system 308 and the SNS system 310 may permit an access from a non-employee user who is outside the corporation but has special permission.

Among the attribute items of the exemplary work style information illustrated in FIG. 2, the information of the commute time and the number of vacation days is collected from the work time management system 302. The information of the number of private trip times is collected from the welfare service system 306. The information of the number of business trip times and the number of meeting times is collected from the scheduling system 304. The information of the number of acquaintances in and outside the office and the number of communities in attendance is obtained from the SNS system 310. For example, the number of acquaintances in and outside the office may be obtained by counting the number of the other participants in each community, on which the user participate, in the SNS system 310, and by obtaining the total number of persons in the office and the total number of persons outside the office. The number of information posting times is obtained by counting posting of information (for example, a document, a spread sheet, an article of a bulletin board, an image, and a movie) to the document management system 308 and the SNS system 310 from all users. The number of information browsing times is obtained in a similar way.

The multifaceted information collection unit 210 provides a collecting service of multifaceted information for the user through the information terminal 100. The “multifaceted information” mentioned here is information having wide variety as possible in the aspect of the writer's personality. In this exemplary embodiment, users (writers) are selected from multiple users (writers) as subjects of a collection of posted information, by focusing on the attributes of the users (writers). This selection is made based on a policy that persons having different attribute values in each are selected as far as possible from a limited number of persons. Information posted by the selected users is collected through an information centralization system 320.

The function of the multifaceted information collection unit 210 is divided into a condition designation reception unit 212, a collection subject selection unit 214, and a collection request unit 216. The condition designation reception unit 212 receives designation of information collection conditions from the information terminal 100. The collection subject selection unit 214 selects various writers from records of users stored in the work style information storage unit 202, in accordance with the information collection conditions. The collection request unit 216 requests the information centralization system 320 for collection of information posted by the selected writers, and provides the information collected in accordance with the request to the information terminal 100.

The information centralization system 320 collects the information posted by the users and requested by the collection request unit 216 from information sources, such as the document management system 308 and the SNS system 310, through the network, and provides the collected information to the collection request unit 216.

The overview of the system has been described above. Now, the details will be described below.

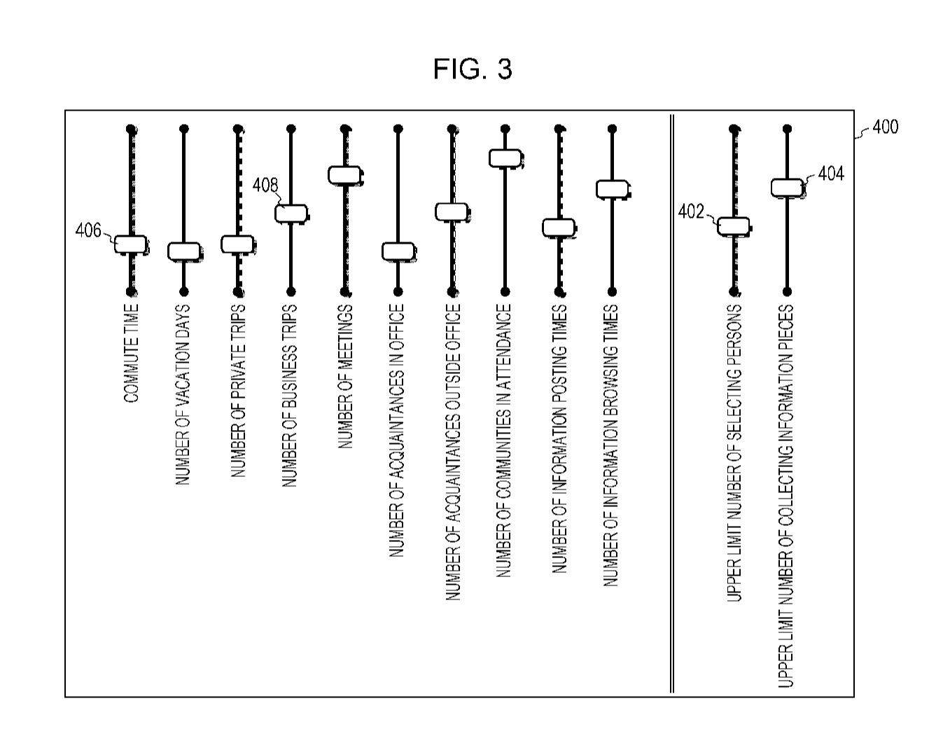

Referring to FIG. 3, setting of the information collection conditions by the user with the information terminal 100 will be described. FIG. 3 illustrates an example of a setting window 400 for the information collection conditions displayed on the information terminal 100. The setting window 400 is configured as a graphical user interface (GUI). The information collection conditions set with the setting window 400 are roughly divided into groups: the number of information pieces to be collected and a condition that ensures variety.

The condition relating to the number of information pieces to be collected corresponds to two items on the right side in FIG. 3, i.e., an “upper limit number of selecting persons” and an “upper limit number of collecting information pieces.” The upper limit number of selecting persons is an upper limit value of the number of users who are sources (posting sources) of information to be collected. For example, the upper limit value of the number of selecting persons may be increased and decreased by moving up and down a slide bar 402, which is a GUI part, with a pointing device or the like. Also, the “upper limit number of collecting information pieces” is an upper limit value of the number of information pieces that the user wants to collect. In this case, similarly, the upper limit value may be increased and decreased by moving up and down a slide bar 404. Provided a limitation such that at least a single piece of information is collected from each of the selected writers, the upper limit number of collecting information pieces may be selected only from values larger than the upper limit number of selecting persons.

The condition that ensures variety is designated as a division number by which the range of attribute values in each attribute item of users, such as the “commute time” and “the number of vacation days,” is divided. To be more specific, in this exemplary embodiment, the entire range of values that are expected to be set in an attribute item is divided into plural ranges (sections) which are not overlapped with each other, and users who respectively meet the divided ranges are selected as information sources. Accordingly, the variety of writers is ensured.

For example, regarding the “commute time,” if the division number is designated to three by a slide bar 406, the distribution range of commute time of users is divided into three, and an information source is selected from each of the three divided ranges to include at least one person from each divided ranges. In addition, regarding “the number of business trips,” if the division number is designated to five by a slide bar 408, the distribution range of the number of business trips of users is divided into five, and an information source is selected from each of the five divided ranges to include at least one person from each divided ranges. Accordingly, in this example, at least three persons are selected in the aspect of the “commute time,” at least five persons are selected in the aspect of “the number of business trips,” and hence at least eight persons in total are selected as information sources.

It is to be noted that there may be an attribute item to which a division number is not designated. In this case, any writer is not selected in the aspect of such an attribute item. For example, an operation system determines “not to designate a division number” when the slide bar 406 indicates “zero.”

Here, since at least one writer is selected from each divided range, the sum of the division numbers set for the respective attribute items has to be the “upper limit number of selecting persons” or smaller. The range selectable by the slide bar of each attribute item may be limited so that the sum of the division numbers becomes the “upper limit number of selecting persons” or smaller.

The writers are selected such that the numbers of selecting persons become as even as possible for the divided ranges. To be more specific, if the total number of divided ranges is three and the upper limit number of selecting persons is six, two persons are selected from each of the three divided ranges. If the upper limit number of selecting persons is not divided evenly by the total number of divided ranges, persons are selected by the same number for each of the ranges within the upper limit, and the remainder may be left unused. Alternatively, persons may be selected by the same number for each of the ranges within the upper limit, and the remainder may be allocated to part of the ranges by one each. An operator of this system may determine either of these methods.

Similarly, the information is collected by an even number of information pieces from the selected writers. If the upper limit number of collecting information pieces is not divided evenly by the number of selected writers, the information is collected by the same number of pieces from each of the writers, and the remainder may be left unused. Alternatively, the information may be collected by the same number of pieces from each of the writers, and the remainder may be allocated to part of the writers by one each. The operator of this system may determine either of these methods.

The window for designating collection conditions may be provided by a collection condition designation program that is installed in the information terminal 100 (if the condition storage unit 110 is included in the information terminal 100), or may be provided by the condition storage unit 110, for example, in the form of an Web page.

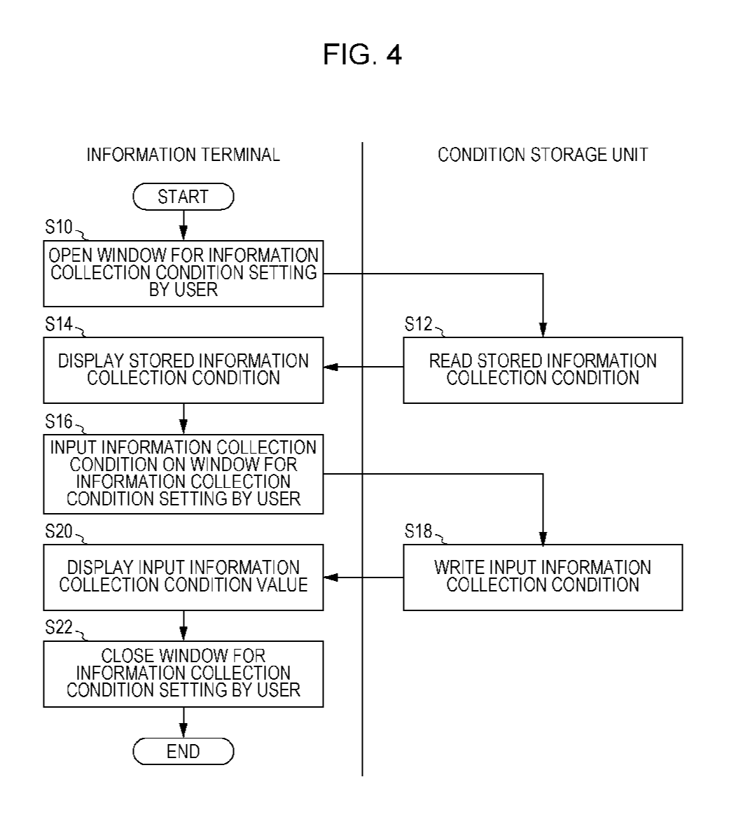

Now, a flow of designating the collection conditions will be described with reference to FIG. 4. In this example, when a user operates the information terminal 100 and opens a window for information collection condition setting (S10), information collection conditions set by the user are read from the condition storage unit 110 (S12), and the information collection conditions are displayed on the window of the information terminal 100 (S14). In the window, the positions of slide bars for respective items are calculated in accordance with the values of respective items of the read information collection conditions. If the user designates the information collection conditions for the first time, default setting is displayed. The user sets the values of the respective items by moving the slide bars for the respective items on the window (S16). The item's values for the information collection conditions of the condition storage unit 110 of the user are updated in accordance with the item's values input in this way (S18). As the result of the update, the updated item's values are displayed on the window of the information terminal 100, at corresponding positions of the respective slide bars or in the form of a list indicative of the item's values (S20). If the information collection conditions checked by the display meet the desire of the user, the user closes the setting window for the information collection conditions, and ends the setting operation (S22).

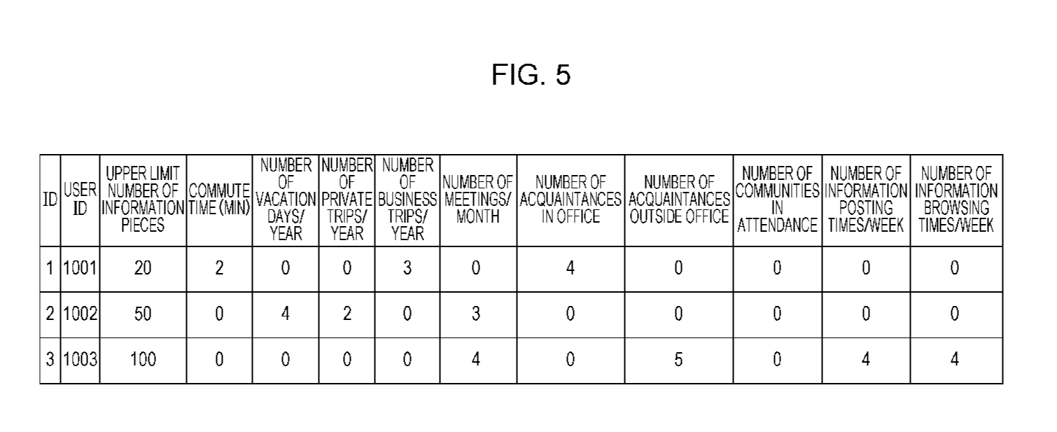

FIG. 5 illustrates an example of the information collection conditions of the respective users stored in the condition storage unit 110 in the manner as described above. This is an example when conditions for plural persons are stored in the condition storage unit 110. A single row in a table shown in FIG. 5 corresponds to conditions for a single user. For example, a user with a user ID “1001” has conditional setting such that an upper limit number of collecting information pieces is twenty, the range is divided into two for the attribute of the commute time, the range is divided into three for the attribute of the number of business trips, and the range is divided into four for the attribute of the number of acquaintances in the office, while other attributes are not considered. Although not illustrated in FIG. 5, the condition storage unit 110 also stores the upper limit number of selecting persons. It is assumed that the user with the user ID “1001” has the upper limit number of selecting persons of ten. With these conditions, the sum of the division numbers of the interested three attribute ranges is expressed by 2+3+4=9. It is assumed that one person is selected from each range, i.e., nine persons in total are selected under the condition that the upper limit number of selecting persons is ten (when the method with the remainder left unused is employed). In this case, the twenty pieces, which is the upper limit number of collecting information pieces, is divided by nine, and hence two information pieces is collected per each person (when the method with the remainder left unused is employed).

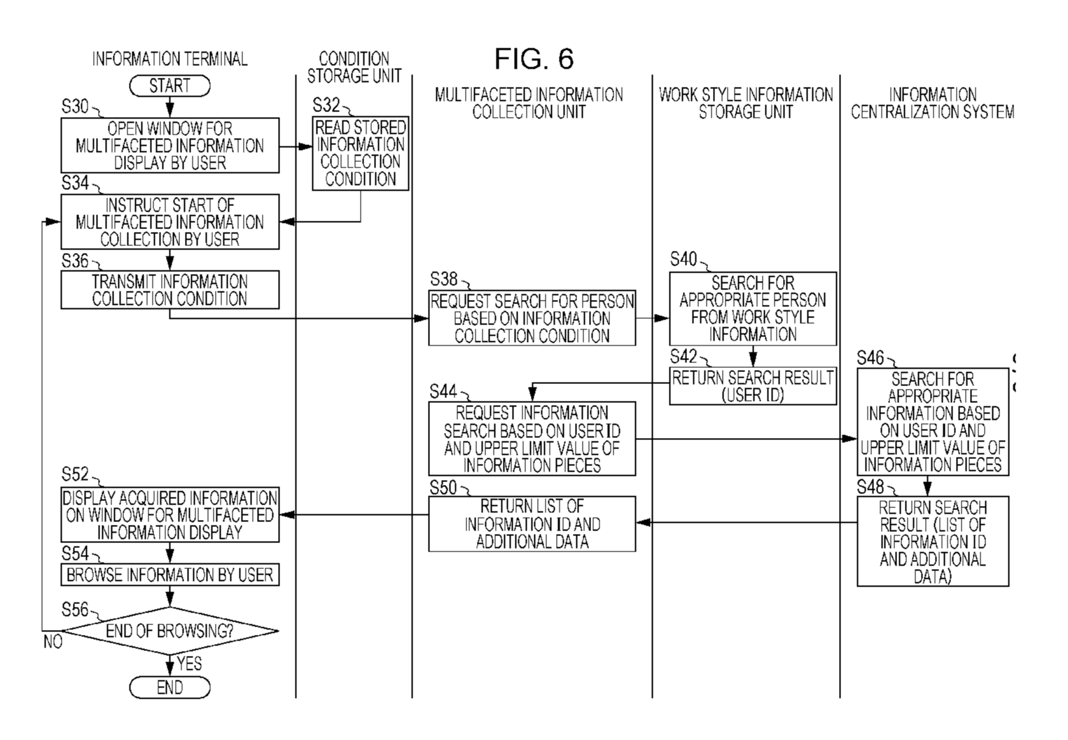

Now, a flow of collection of information under information collection conditions set by a user according to this exemplary embodiment will be described with reference to FIG. 6. When a user starts up a multifaceted information display tool that is installed in the information terminal 100, logs in the tool, and opens a window (S30), the tool sends a user ID of the user to the condition storage unit 110, and acquires data of information collection conditions of the user (S32). When the user instructs the tool for the start of collection for the multifaceted information (S34), the tool transmits the information collection conditions to the multifaceted information collection unit 210 of the information collection and management device 200 through a network, and requests the collection of information that meets the conditions (S36).

In the multifaceted information collection unit 210, the condition designation reception unit 212 receives the request including the information collection conditions. The collection subject selection unit 214 requests selection of writers, who are collection subjects of information, to the work style information storage unit 202 in accordance with the upper limit number of selecting persons and information of division numbers for ranges of respective attribute items included in the information collection conditions (S38). With this selection request, the entire range of values that are expected to be set in each attribute item is divided into a number of ranges (division number) that is determined in the information collection condition of that attribute item, and a request is made to the work style information storage unit 202 to obtain users having attribute values that belong to the respective divided ranges. The work style information storage unit 202 that has received the request, for example, randomly selects writers by a number of persons, which is obtained by allocating the upper limit number of selecting persons evenly to the respective divided ranges, from among the users having the attribute values that belong to the respective divided ranges (S40). User IDs of the selected users are returned to the collection subject selection unit 214 (S42). The collection subject selection unit 214 gives a list of the selected user IDs to the collection request unit 216.

The collection request unit 216 gives the received list of the user IDs and the upper limit number of collecting information pieces determined in the information collection conditions to the information centralization system 320, and requests to collect information (S44). The information centralization system 320 obtains the number of collecting information pieces per one person by allocating the upper limit number of collecting information pieces evenly to the respective users in the received list, and searches for and acquires the collecting information pieces per one person from information posted in the document management system 308 and the SNS system 310 by the users (S46). With this search, if there are plural information source devices which are posting targets of information (for example, the document management system 308 and the SNS system 310), information pieces may be collected evenly from the respective information sources as far as possible. In the information sources, information pieces that have been posted at various timings from the past to the current are usually existed mixedly. Hence, in the search processing in S46, information to be provided may be searched from information posted at a recent time. For example, the collecting number of information pieces may be searched in order from the latest information posted by the selected writers. Also, the last request time of the user who requests the collection may be recorded in, for example, the multifaceted information collection unit 210, and the collecting number of information pieces may be searched from information posted after the last request time in S46. Other various methods may be conceived.

In this way, when the collecting number of information pieces posted by each user (writer) of the collection subject is collected, the information centralization system 320 returns the IDs and additional information (if provided) of the information to the collection request unit 216 (S48). Herein, an unique ID (identification information) may be assigned to each piece of information posted to various information sources, such as the document management system 308 and the SNS system 310, and the ID may be used as an information ID. Alternatively, a combination of identification information (for example, domain name) that specifies a device of each information source and a storage location (for example, path name) in the device, or a uniform resource locator (URL) of each piece of information may serve as an information ID. Also, examples of the additional information may be attribute information (creator name, date and time of creation, file size, summary, etc.) of collected information.

The collection request unit 216 returns the list of the information IDs and the additional information, the list which is the collection result acquired from the information centralization system 320, to the information terminal 100 that has originally made the request (S50). The list may be provided in the form of a Web page in which, for example, links to the respective pieces of information and the additional information are listed. The information terminal 100 displays the received list on a window (S52). The user selects information that the user wants to browse from the list, and browses the information (S54). After browsing, the user may return to S34 to check whether the information is updated or not after the last collection of information, and may instruct to re-collect information (S56). If the user performs an operation for the end of browsing on the displayed window of the tool in S56, the series of processing is finished.

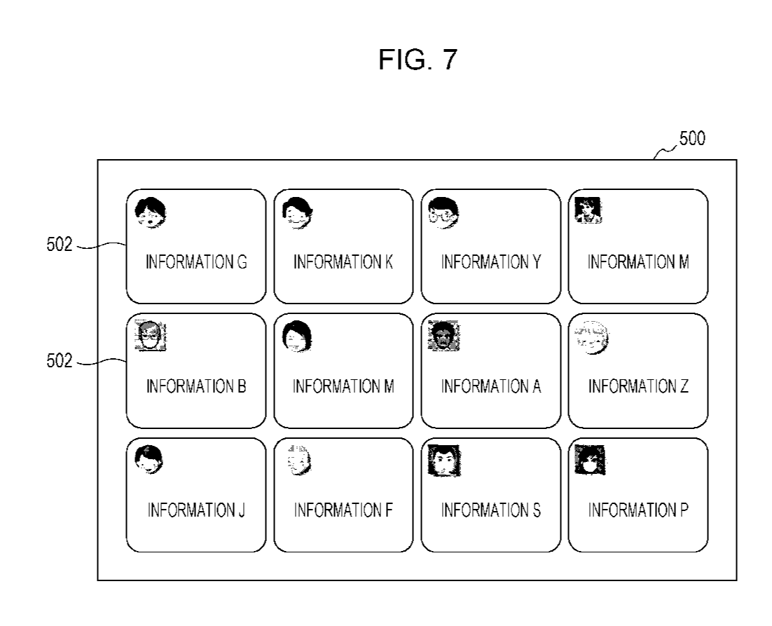

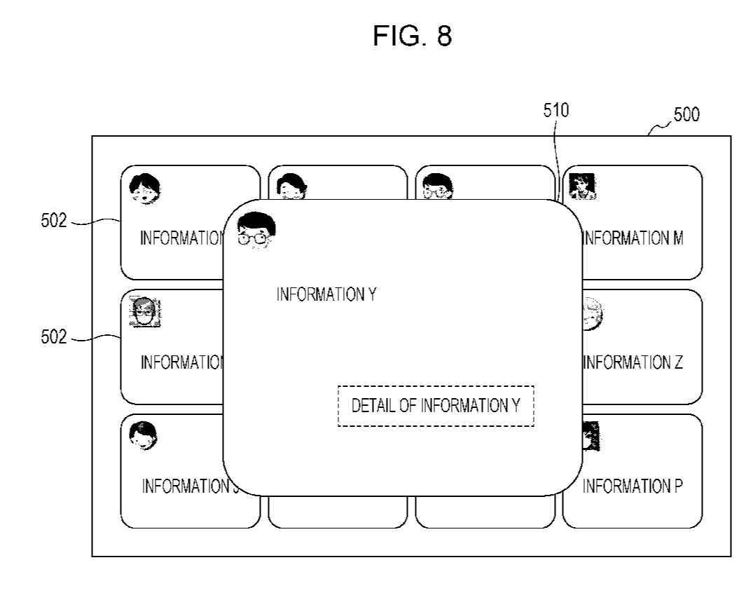

FIG. 7 illustrates an example of a list window 500 as the collection result displayed on the information terminal 100 in S52. In this example, icons 502 indicative of twelve pieces of information of the collection result are arranged on the list window 500. For easier identification of information by a user, additional information such as creator names and avatar images may be displayed in the respective icons 502. The icons 502 may be two-dimensionally arranged as shown in FIG. 7, or may be arranged in other manner. The collected information is multifaceted information listed in no particular order of superiority or inferiority etc. Owing to this, the collected pieces of information may be arranged so that the user does not feel an intention of a certain order and hence the user who browses the information is not biased (for example, the pieces of information may be randomly arranged such as when cards are spread on the floor). Alternatively, the icons may be arranged in an overlapped manner. The icons 502 are respectively associated with IDs of information pieces indicated by the icons. If the user designates an icon 502 of information that the user wants to browse by a click or the like, the multifaceted information display tool of the information terminal 100 acquires an entity of information corresponding to the information ID of the icon 502 from an information source, and displays the entity of the information on the window. For example, if an icon of information Y is designated in the example shown in FIG. 7, an entity of the information Y is acquired and a detail window 510 indicative of the entity of the information is displayed at the center of the list window 500 as shown in FIG. 8. Of course, after a detail window indicative of certain information is browsed, the detail window may be closed, and a detail window of another information may be browsed.

In the above example, the list of the collected information IDs is provided to the information terminal 100. Alternatively, collected information itself may be provided to the information terminal 100 instead of the list.

Also, in the above example, the multifaceted information collection unit 210 performs the processing for the collection of information in response to the instruction for the collection of information from the user. However, this is merely an example. Alternatively, the information collection and management device 200 may register information collection conditions of respective users, periodically collect information in accordance with the conditions, and distribute the information to the information terminal 100.

Also, in this exemplary embodiment, persons selected from user groups corresponding to ranges of each attribute item divided in accordance with information collection conditions may be changed every time when information is collected, or may be randomly changed at a certain time interval. Accordingly, the variety of information to be collected is further increased.

Also, the information terminal 100 or the information collection and management device 200 may periodically recommend a user to change or review the information collection conditions. The recommendation may be made on a mobile tool, for example, by displaying a message that recommends a user to change setting for the information collection conditions, on a window of the multifaceted information collection tool. If information is collected for a long period under the same conditions, the user who browses the information may get used to the way of collection, and the collection become mere routine. To avoid this, the user may be periodically recommended to change the conditions.

Also, although the user intends to collect many pieces of information and browse the information at the beginning, as the user actually operates this system, the user may frequently have difficulty to browse many pieces of information because the user does not have a time. If such a state is left unaddressed, the user may be indebted for that user's goal may not be attained. This may put the user away from the cycle of collecting and browsing information. Therefore, the information collection and management device 200 or the information terminal 100 may monitor the amount of information that is actually browsed by the user, from among information of the collection result provided by the information collection and management device 200 to the information terminal 100. If a ratio of the amount of information actually browsed by the user to the amount of collected information is a predetermined ratio or smaller, the information collection and management device 200 or the information terminal 100 may automatically suggest the user to decrease the upper limit value of the number of collecting information pieces. Alternatively, a request for an information entity corresponding to an information ID from the information terminal 100 may be transmitted to the information collection and management device 200, and the information collection and management device 200 may acquire information corresponding to the information ID from a device of an information source and provide the information, so that the information collection and management device 200 recognizes the amount of information actually browsed by the user. Through monitoring, if the ratio of the amount of information actually browsed by the user to information in the list of the collection result is smaller than the predetermined ratio, a monitoring tool installed in the information collection and management device 200 or the information terminal 100 may transmit a message for recommending the user to perform resetting to decrease the upper limit value of the number of collecting information pieces to the information terminal 100.

The information terminal 100 and the information collection and management device 200 exemplified above are provided, for example, by causing a general-purpose computer to execute a program that represents processing of the aforementioned respective function modules. The computer has, for example, a circuit configuration including, as hardware, a microprocessor such as a central processing unit (CPU), memories (primary memories) such as a random-access memory (RAM) and a read-only memory (ROM), an HDD controller that controls a hard disk drive (HDD), various input/output (I/O) interfaces, and a network interface that performs control for connection with a network such as a local area network. These units are connected through, for example, a bus. Also, a disk drive that reads and/or writes data from and/or on a portable disk storage medium, such as a compact disc (CD) or a digital versatile disc (DVD), or a memory reader/writer that reads and/or writes data from and/or on a potable non-volatile storage medium of any of various standards, such as a flash memory, may be connected to the bus through, for example, an I/O interface. The program having written therein the processing contents of the function modules exemplified above is saved in a fixed storage device, such as the hard disk drive, through the storage medium, such as the CD or DVD, or through a communication way, such as a network, and is installed in the computer. The program stored in the fixed storage device is read to the RAM, and is executed by the microprocessor such as the CPU. Accordingly, the function modules group exemplified above is provided.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A computer readable medium storing a program causing a computer to execute a process for collection of information, the process comprising:
receiving a division condition of a value range of an attribute from a user;
dividing the value range of the attribute into a plurality of ranges under the received division condition;
selecting writers who have an attribute value corresponding to the respective divided ranges of the attribute by referencing a writer information storage unit that stores values of the attribute of the writers;
collecting information that is posted by the selected writers from a posted information storage device that stores information posted by the writers; and
providing the collected information to the user.

2. The computer readable medium storing the program according to claim 1, the process further comprising:
receiving a number of pieces of information to be provided from the user, and
wherein the collecting includes collecting the information posted by the writers by the number of pieces of information to be provided from the posted information storage device so as to contain the information posted by each of the selected writers.

3. The computer readable medium storing the program according to claim 2, the process further comprising:
monitoring the number of pieces of information browsed by the user among the provided information to the user; and
decreasing the number of pieces of provided information if a ratio of the number of pieces of information actually browsed by the user to the number of pieces of provided information is equal to or smaller than a predetermined ratio.

4. The computer readable medium storing the program according to claim 1, wherein the selecting includes changing the writers to be selected from the writers previously selected, within a range of the writers who have the values that belong to the divided ranges.

5. The computer readable medium storing the program according to claim 1, the process further comprising recommending the user to modify the division condition.

6. An information collection support system, comprising:
a division condition reception unit that receives a division condition of a value range of an attribute from a user;
a selection unit that divides the value range of the attribute into a plurality of ranges under the division condition received by the reception unit, and selects writers who have an attribute value corresponding to the respective divided ranges of the attribute by referencing a writer information storage unit that stores values of the attribute of the writers; and
a provision unit that collects information that is posted by the selected writers from a posted information storage device that stores information posted by the writers, and provides the collected information to the user.

7. A method for collection of information, comprising:
receiving a division condition of a value range of an attribute from a user;
dividing the value range of the attribute into a plurality of ranges under the received division condition;
selecting writers who have an attribute value corresponding to the respective divided ranges of the attribute by referencing a writer information storage unit that stores values of the attribute of the writers;
collecting information that is posted by the selected writers from a posted information storage device that stores information posted by the writers; and
providing the collected information to the user.
